(19) United States
(12) Patent Application Publication
(10) Pub. No.: US 2024/0296846 A1
(43) Pub. Date: Sep. 5, 2024

(54) VOICE-BIOMETRICS BASED MITIGATION OF UNINTENDED VIRTUAL ASSISTANT SELF-INVOCATION

(71) Applicant: GM GLOBAL TECHNOLOGY OPERATIONS LLC, Detroit, MI (US)

(72) Inventors: Luke Heide, Plymouth, MI (US); Gaurav Talwar, Novi, MI (US)

(73) Assignee: GM GLOBAL TECHNOLOGY OPERATIONS LLC, Detroit, MI (US)

(21) Appl. No.: 18/177,211

(22) Filed: Mar. 2, 2023

(51) Int. Cl. G10L 17/02; G10L 15/08; G10L 25/51

(52) U.S. Cl. CPC G10L 17/02; G10L 15/08; G10L 25/51; G10L 2015/088

(57) ABSTRACT

A voice-biometrics based solution for unwanted self-invocations by virtual assistant applications is proposed. In various embodiments, a processing system is configured to control a virtual assistant. The processing system may have stored in a memory at least one voiceprint created using voice biometrics based on recorded utterances of synthetic speech from the virtual assistant. The at least one voiceprint may be used to prevent self-invocation of a virtual speech session by matching the voiceprint created using the synthetic speech utterances with the incoming audio stream.

### INTRODUCTION

Virtual assistants (VAs) that take advantage of speech recognition technologies have been increasingly popular among consumers. VAs have been embedded in a wide variety of devices. Tasks relevant to VAs may include, for example, dictating text, responding to requests and instructions, providing responsive information and web pages, finding directions, activating other programs, etc. VAs may be invoked and then queried using short-cut phrases, speech commands, and verbal prompts on a mobile device, tablet, smart watch, personal computer, and other devices, to execute functions responsive to speech input.

One particularly attractive scenario for using VAs involves a driver in a vehicle. Because the driver's attention to the road is essential, the driver is understandably limited in the actions he or she can take to use technology while driving. Consequently, instructions and commands in the form of speech, prefaced by a wake word to invoke the system to listen for input and respond accordingly, has a high appeal in the automotive industry.

In spite of the technological advances of VAs, shortcomings persist. For instance, a common problem involves an unintended self-invocation of the VA when the system incorrectly concludes that it has received the wake word based on content of synthetic speech from a loudspeaker that also is input into the microphone. This problem, while commonplace across the different applications of VA technology, is equally prevalent in VAs embedded in vehicles in which synthetic speech output from the loudspeaker is evaluated as a potentially legitimate audio stream.

### SUMMARY

In an aspect of the present disclosure, an apparatus includes a processing system configured to control a virtual assistant. The processing system has stored in a memory at least one voiceprint created using voice biometrics based on recorded utterances of synthetic speech from the virtual assistant. The at least one voiceprint is used to prevent self-invocation of a virtual speech session.

In various embodiments, the apparatus includes an amplifier coupled to the processing system. Loudspeakers may be coupled to the amplifier. The apparatus may also include a microphone. The processing system may be encased in a vehicle. The loudspeakers and the microphone may be positioned to include one or more respective outputs and inputs in a cabin of the vehicle.

In various embodiments, the processing system may be further configured to generate voice prompt data including a wake word. The processing system may send the voice prompt data to the amplifier to allow audio reproduction over the loudspeakers. The processing system may receive the audio information via the microphone. The processing system refrains from invoking a new speech session when the received audio information matches the at least one voiceprint. The processing system invokes a new speech session when the audio information includes the wake word, and the wake word does not match the synthetic voiceprint.

In various embodiments, the at least one voiceprint is created using convolved variants of the synthetic speech specific to an environment of the vehicle and characteristics of the microphone that reproduce undesired invocations of the virtual assistant. The processing system may be further configured to store live voiceprints in the memory based on speech utterances of an intended user. In some embodiments, the processing system is further configured to recognize an intended user based on the stored live voiceprints to thereby enable a barge-in via the microphone while speech playback is active over the loudspeakers.

In various embodiments, the synthetic utterances include a plurality of noisy and convolved variants thereof. The voice biometrics may include text-to-speech (TTS)-based synthetic rendering of one or more trigger words. In some embodiments, the processing system is configured to iteratively process a received audio stream. That is, when active acoustic input from an intended user and speech playback of the virtual assistant overlap in time, the processing system may test the voice biometrics sequentially and repetitively to mitigate an undesired invocation of a virtual session.

In another aspect of the disclosure, a vehicle discloses a processing system. The processing system includes a memory and an audio processing engine. The memory includes code that, when executed by the processing system, controls a virtual assistant. The audio processing engine is coupled via at least one audio path to loudspeakers and a microphone to route data including a prompt from the processing system to the loudspeakers for acoustic playback and to receive acoustic data from the microphone. The microphone is configured to receive a wake word for activating the virtual assistant. The memory is configured to store at least one voiceprint including a wake word created based on pre-recorded utterances of synthetic speech from the virtual assistant. The at least one voiceprint is used by the processing system to prevent self-invocation of a virtual speech session by determining whether the received wake word includes the at least one voiceprint.

In various embodiments of the vehicle, the microphone is coupled to an input of the audio processing engine. The loudspeakers may be coupled to an output of the audio processing engine. The loudspeakers and the microphone may be configured to output voice information and receive input acoustic data, respectively. The audio processing engine may be configured to compare the input acoustic data with at least one preconfigured voiceprint created using utterances of an intended user to enable barge-in while speech feedback is currently active.

In various embodiments of the vehicle, the processing system is preconfigured to create the at least one voiceprint by convolving synthetic speech utterances to emulate speech made in a cabin of the vehicle. The processing system may be preconfigured to create the at least one voiceprint by mixing noise into synthetic speech utterances that emulates noise made in a cabin of the vehicle. The memory includes code that, when executed by the processing system, causes the processing system to iteratively process an audio stream when a live speech session and synthetic speech playback from the virtual assistant overlap in time. The audio processing engine may be configured to cause voice biometrics processing to occur sequentially between the live speech session and the synthetic speech playback to mitigate an unintended invocation.

In another aspect of the disclosure, a virtual assistant (VA) apparatus includes a processing system configured to retrieve from a cloud one or more voiceprint variants created using pre-recorded utterances of synthetic speech made in a vehicle cabin. The one or more voiceprint variants include a wake word. The processing system is configured to receive speech input via a microphone positioned in the vehicle cabin. The processing system is further configured to compare the speech input to the one or more voiceprint variants and to prevent self-invocation of a virtual speech session when the speech input matches the one or more voiceprint variants.

In various embodiments, the processing system is further configured to respond using synthetic speech to a verbal request of a user to perform an action. The processing system may create at least one voiceprint based on the responsive synthetic speech. The processing system may further perform the requested action. The processing system may still be further configured to create a live voiceprint based on speech utterances of the user. The live voiceprint may be created for authenticating the user in a subsequent session.

In various embodiments, the processing system is configured to confirm a verbal request of the user based on the speech utterances of the user using a text-to-speech converter while in a current active mode. When the user interrupts the current active mode to barge in with another request, the processing system may be configured to suspend the current active mode and to accommodate the other request if the other request matches a user voiceprint. The processing system may be further configured to record variants of user speech including a wake word, and to upload voiceprints created therefrom to the cloud.

The above summary is not intended to represent every embodiment or every aspect of the present disclosure. Rather, the foregoing summary merely provides an exemplification of some of the novel concepts and features set forth herein. The above features and advantages, and other features and attendant advantages of this disclosure, will be readily apparent from the following detailed description of illustrated examples and representative modes for carrying out the present disclosure when taken in connection with the accompanying drawings and the appended claims. Moreover, this disclosure expressly includes the various combinations and sub-combinations of the elements and features presented above and below.

### BRIEF DESCRIPTION OF THE DRAWINGS

The accompanying drawings, which are incorporated into and constitute a part of this specification, illustrate implementations of the disclosure and together with the description, explain the principles of the disclosure.

FIG. 1 is a conceptual diagram of an example interior of a vehicle cabin in which the principles of the present disclosure may be practiced.

FIG. 2 is a block diagram of an example architecture of a speech-assisted virtual assistant apparatus according to various embodiments.

FIG. 3 is a flowchart describing techniques for mitigating unintended invocation of a virtual assistant according to various embodiments.

FIG. 4 is a flowchart describing techniques for allowing a user barge-in upon recognizing the user's voiceprint.

The appended drawings are not necessarily to scale and may present a simplified representation of various features of the present disclosure as disclosed herein, including, for example, specific dimensions, orientations, locations, shapes. In some cases, well-recognized features in certain drawings may be omitted to avoid unduly obscuring the concepts of the disclosure. Details associated with such features will be determined in part by the particular intended application and use environment.

### DETAILED DESCRIPTION

The present disclosure is susceptible of embodiment in many different forms. Representative examples of the disclosure are shown in the drawings and described herein in detail as non-limiting examples of the disclosed principles. To that end, elements and limitations described in the Abstract, Introduction, Summary, and Detailed Description sections, but not explicitly set forth in the claims, should not be incorporated into the claims, singly or collectively, by implication, inference, or otherwise.

For purposes of the present description, unless specifically disclaimed, use of the singular includes the plural and vice versa, the terms “and” and “or” shall be both conjunctive and disjunctive, and the words “including,” “containing,” “comprising,” “having,” and the like shall mean “including without limitation.” For example, “optimal vehicle routes” may include one or more optimal vehicle routes. Moreover, words of approximation such as “about,” “almost,” “substantially,” “generally,” “approximately,” etc., may be used herein in the sense of “at, near, or nearly at,” or “within 0-5% of”, or “within acceptable manufacturing tolerances”, or logical combinations thereof. As used herein, a component that is “configured to” perform a specified function is capable of performing the specified function without alteration, rather than merely having potential to perform the specified function after further modification. In other words, the described hardware, when expressly configured to perform the specified function, is specifically selected, created, implemented, utilized, programmed, and/or designed for the purpose of performing the specified function.

In recent years, due to enhancements in speech-recognition technology and the convenience of augmenting devices with speech as an input method to issue instructions and requests and to transcribe text, the popularity of VA systems has increased. A VA is an apparatus that may respond to commands or questions and perform tasks electronically. Examples of VAs include, among others, Amazon's Alexa™, Apple's Siri™, and Google's assistant. VAs ordinarily use a layered scheme of self-learning algorithms to detect speech input into a microphone, which in turn is converted into electrical signals by the microphone, filtered to eliminate energy in the non-speech frequency spectrum, and interpreted by a processor. Upon recognizing relevant speech patterns as instructions, for example, the VA engine may perform one or more different tasks in response to the instructions. The use of speech via a VA adds convenience and efficiency because it may often obviate the need for the user to make copious manual entries through an existing user interface (such as a touch screen or keyboard).

VAs may use a trigger word or wake word to recognize that they have been invoked via speech. One relevant aspect of VA technology is the concept of the wake word, sometimes called the trigger word. For purposes of this disclosure, a wake word may include either a single word, or more than one word, such as a phrase. The processing system associated with the particular VA may include a wake word detector, which may in turn be implemented using executable code, or a combination of hardware and software. The wake word detector may be active even when the device (e.g., a smartphone) is otherwise idle. The wake word detector's function is to listen for a user to articulate or utter a particular word, term, or phrase that has been preconfigured to activate the assistant. Once activated, the VA may begin a session in which it is listening for a command or instruction asking the VA to perform some task. To facilitate these actions and to interpret further sounds into comprehensible dialog, the VA may include a text-to-speech (TTS) converter. The VA may use a natural language algorithm to attempt to interpret the substance of the speech. Thereupon, upon successfully comprehending the request, the VA may fulfill the request, if capable and authorized.

While VAs are commonly used on mobile devices, tablets, and personal computers (PCs), VAs are also found in vehicles and used in an increasing number of electronic appliances. Thus, the VA and its applications are diverse in nature.

As one example of the present disclosure, a VA may be embedded in a processing system in a vehicle for use in the interior of the vehicle cabin. In various aspects, the system includes, in addition to an interior processing system incorporating the audio engine, one or more loudspeakers and microphones for outputting and receiving audio signals, respectively, to and from the cabin interior. The microphone(s) may enable a driver or other user to enter speech including audio prompts into the microphones. Generally, the microphones pick up the spectrum of cabin noise, such that if the VA through the loudspeakers happens to be contemporaneously outputting speech to the driver, that speech may also be picked up by the microphones. In some common scenarios, the speech output by the processing system via the loudspeakers may include one or more VA wake word instances originating from the loudspeakers as synthetic speech. These wake work instances may be recognized as legitimate requests to activate a new speech session, thereby giving rise to an unintended self-invocation of a new VA speech session. The incorrect invocation may also cause a current active VA session to be terminated.

A number of voice biometrics techniques are available to recognize the user's speech. In addition to the standard formats and protocols of Siri™, Alexa™, and similar VAs for performing tasks, these and other VA applications may also be used for security in the form of user voice identification. That is, access to a VA or a related user resource may be based on the voiceprint of a user's previously-recorded articulation(s) of a wake word or phrase, or other speech during the initial setup of the VA. In the context of security, this wake word may be used as a substitute to the standard four-digit use of personal identification numbers (PINs), for example. One advantage of using voice biometrics in a security context is that the customer experience can be enriched when tedious login processes are replaced by the use of straightforward user speech patterns.

Existing implementations in VA training may be conducted by a live user, such as an authorized user of a vehicle. In various aspects of the disclosure, to mitigate the above-described self-invocation problems, the processing system may create a synthetic voiceprint during setup of the VA. That is, the rich voiceprint of the text-to-speech (“TTS”)-based synthetic rendering over the loudspeaker(s) may be used when initially training the VA to differentiate synthetic speech (which may include utterances of a wake word) from other speech. As an example, during a subsequent VA session, the synthetic speech reproduced over the loudspeaker(s) is input into one or more microphones. The processing system may compare the audio stream corresponding to the input synthetic speech to the original synthetic voiceprint. In the event of a match, the processing system may ignore the synthetic audio stream.

In other embodiments, during the initial training, a loudspeaker may be prompted to utter multiple instances of a word or speech pattern. Because they may take into account cabin noise and other variables, these multiple instances of the key word utterance may be used to avoid unintended invocation of the VA. Thus, the training instances during the VA setup may comprise noise and convolved variants of the voiceprint. The greater number of speech samples from the user, the richer the user voiceprints. In case of successful identification (e.g., the processing system matches the user's input audio stream to the user's voiceprint), the voice dialog corresponding to a current speech session may be desisted and the processing system may classify a wake word uttered by the user within that stream as a genuine invocation.

Typically, during a standard VA when the loudspeakers are actively identifying information to a user (e.g., giving requested directions, clarifying a request or instruction, etc.), the microphone is simultaneously engaged to listen for voice input. One reason for this configuration is that a user experienced with the VA may wish to interrupt the present information from the VA (e.g., “please say the number that you wish to call at this time”) and begin speaking immediately with the phone number. Thus, a user need not be held “hostage” by the VA's potentially long phrases and instructions that may be already familiar to the user. The user may instead interrupt the VA and recite a response, for example.

The benefits of this setup may be offset by disadvantages. One such disadvantage involves the common situation when the VA's synthetic recitations include reference to one or more wake words. The wake word (which may include a phrase), in turn, may be input via the microphones and transduced to electrical audio signals, not unlike that of a human speaking a phrase to initiate a new session or interrupting the present session to begin a new one. Because the audio processing engine may conclude that the synthetic speech being output is in fact speech from a human, or the user, the processing system may interpret a wake word included in the received synthetic audio data as an instruction to start a new session. The processing system may then terminate the existing session in favor of a new one, even if, for instance, the actual user is in midsentence in responding to the VA's prior instruction. In short, this phenomenon may undesirably trigger a VA speech session that was not intended by the user. Such a chain of events may be extremely frustrating to a user, particularly if the user was already in the middle of a productive session with the VA and, due to the session's termination, is forced to start from the beginning. A self-invocation is a new speech session established by the VA based on a mistaken interpretation of a synthetic utterance of the VA including a key word. Active sessions may be interrupted.

Aspects of the present disclosure consequently leverage concepts of speaker identification (voice biometrics) to avoid undesired invocation of virtual assistants resulting from synthetic utterances that include their own wake word. Voice biometrics relates to techniques for using a human voice or speech as a unique identifier of one or more biological characteristics. These characteristics enable a VA, a call center, an automatic voice menu on a telephone, and the like fast, seamless and secure access to information.

More specifically, aspects of the present disclosure are directed to systems, apparatuses and methods for mitigating the occurrence of false invocations by a VA that result from the VA's own synthetic recitations of speech that may include a wake word, which may include a term or phrase preconfigured to trigger the VA to start a new session. As noted, these synthetic audio speech utterances originate from the VA and are fed through the loudspeaker. Thereafter, because they are acoustic waves representing an audio signature in the frequency band of human speech, the synthetic sound waves are successfully captured by the VA's microphone(s). They are converted back into electrical audio signals. The signals may be filtered and ultimately sent to a processor or to a voice biometrics unit within the audio processing engine, where the signals are processed potentially along with other speech signals from a live speaker. The processing system may determine that it has received the wake word from a user, when in actuality the received wake word was originally sourced from the synthetic speech of the VA. The processing system may then conclude that the VA has been invoked via the wake word. As noted, this false invocation may result from the VA erroneously concluding that it has received the wake word in the form of an electrically-transduced input via the microphone, when in fact the wake word was actually included in synthetic audio speech transmitted by the VA. The synthetic audio speech in turn included the wake word, in many cases by happenstance.

The system herein includes a voice biometrics based audio processing system that may mitigate these false positive self-invocations. For example, in various embodiments during initial setup of the VA, the VA may create unique VA-based voiceprints that include convolved variants of the assistant (synthetic) voice in noisy environments such as that of a vehicle cabin. In addition, in various embodiments, the VA may allow for the creation of an iterative audio processing system to allow the VA to function properly in barge-in scenarios. As discussed further below, barge-in is a phenomenon wherein the VA's output speech or display of data is interrupted by a new request, and wherein the processing system terminates the speech session and processes the new request when the audio stream corresponding to the request matches a pre-stored voiceprint established at setup.

Using the voiceprints created from the synthetic utterances of the VA's voice, the VA may thereafter recognize a synthetic audio stream that originates from the processing system of the VA, and differentiate the audio stream from a live user voice. The synthetic utterance may simply be ignored, including a wake word within the utterance. Self-invocation is thereby avoided.

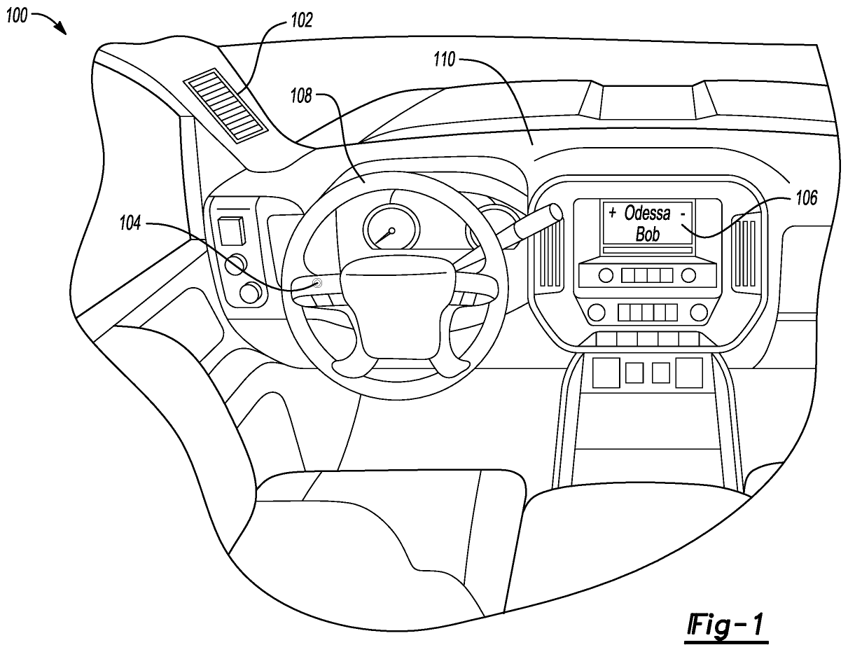

FIG. 1 is a conceptual diagram of an example interior of a vehicle cabin 100 in which the principles of the present disclosure may be practiced. The VA may be embedded in a processing system and related circuitry housed in the vehicle interior, such as within the dashboard 110, or another location. In one embodiment, the wake word “Odessa” is displayed on touch screen 106. Touch screen 106 may be used as a combination input/output device that enables the driver or a user to view output or click on links, as needed. In some embodiments, the touch screen may be part of a larger infotainment system. Also, in some configurations, the input may include dedicated buttons, switches, actuators, etc., located on the dashboard 110 adjacent the output screen or otherwise.

The VA may include microphones to capture the speech of the driver or other vehicle occupants. In the embodiment shown, microphone 104 may be embedded within the steering wheel 108 and used to capture the speech of the driver. Other microphones may be distributed throughout the vehicle cabin as needed. The specific location of the one or more microphones may vary. Similarly, the VA may issue queries, commands, instructions, and data responsive to user queries via one or more loudspeakers, such as loudspeaker 102. One problem addressed by the current disclosure relates to instances where the VA uses an instance of the wake word (e.g., “Odessa”) over loudspeaker 102. The synthetic voice may be captured by microphone 104 and processed in an audio stream, potentially along with other acoustic signals.

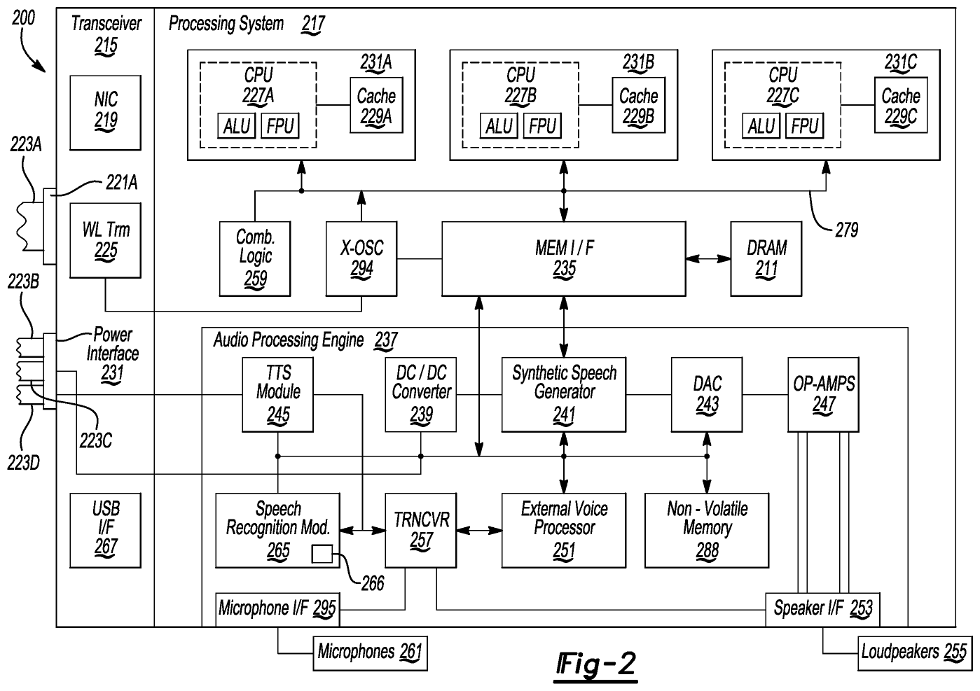

FIG. 2 is a block diagram of an example architecture of a speech-assisted VA apparatus 200 according to various embodiments. While the VA apparatus 200 is illustrated as a single module, in actuality one or more of these structures may be distributed as appropriate through various regions of a vehicle or other device. In some embodiments, the VA apparatus 200 may be included as part of one or more electronic control units (ECUs) of a vehicle. The VA apparatus 200 includes a processing system 217, which may be used to execute code and instructions, and to process signals using hardware components, for realizing the functionality of the VA. Processing system 217 may include processors 231A, 231B, and 231C, for example. Processor 231A may include central processing unit (CPU) 227A. CPU 227A may further include an arithmetic logic unit (ALU) and a floating point unit (FPU), as shown. CPU 227A may be coupled to cache memory 229A for storing frequently used data and instructions. Similarly, processing system 217 may include processor 231B. Processor 231B may include CPU 227B, which in turn may include an ALU and an FPU, along with other hardware elements and combinational logic structures depending on the specific implementation. CPU 227B may also be coupled to cache memory 229B. In various embodiments, cache memory 229B may be included within CPU 227B. In some configurations, the processing system 217 may include a plurality of levels of different cache memory elements.

Processing system 217 further may include processor 231C. Processor 231C may include CPU 227C, which may include an ALU and an FPU (among other elements), as shown. Coupled to CPU 227C is cache memory 229C. While three processors 231A, 231B, and 231C are shown in FIG. 2, in practice the processing system 217 may include one or more processors. The processors 231A, 231B, and 231C may be configured to execute code relating to the various functions of the VA.

Referring still to FIG. 2, processor 231A, processor 231B, and processor 231C may each be coupled to a memory interface circuit 235 via bus 279. Bus 279 may include a variety of metallic traces in a printed circuit board and/or wires or cables for transferring information between components of processing system 217. The memory interface circuit 235 may constitute a northbridge and southbridge chip or it may constitute a single integrated circuit using different protocols depending on the implementation. Using bus 279, memory interface circuit 235 may perform high-bandwidth exchanges of data and instructions between dynamic random access memory (DRAM) 211, the processors 231A, 231B and 231C, non-volatile memory 288, internal transceiver 257, external transceiver 215, and the various remaining modules of the audio processing engine 237. Audio processing engine 237 is considered part of the processing system 217 for purposes of this disclosure, although in practice the different circuits may be physically consolidated or distributed.

It will be appreciated that the terms “processing system” and “processor” for purposes of this disclosure may, but need not, be limited to a single processor or integrated circuit. Rather, they may encompass plural or multiple processors (as in FIG. 2) and/or a variety of different physical circuit configurations. Non-exhaustive examples of the term “processor” include (1) one or more processors, in a vehicle for vehicular implementations or in another device for a VA embedded in the device, that collectively perform the set of functions relevant to a VA and that interface with other components as governed by the relevant specifications of the VA, and (2) processors of potentially different types, including reduced instruction set computer (RISC)-based processors, complex instruction-set computer (CISC)-based processors, multi-core processors, etc.

The voice biometrics of synthetic or user speech described herein, and related tasks, may be executed using software, hardware, firmware, middleware, application programming interfaces (APIs), layered techniques, and combinations of the foregoing. As one example, the processing system 217 may perform tasks using a layered architecture, with operating system code configured to communicate with driver software of physical layer devices, or with dedicated hardware or a combination of hardware-specific functions and executable code.

The processing system 217 may further include memory (e.g., dynamic or static random access memory (e.g., DRAM 211 or “SRAM”)) as noted above. While the embodiment of FIG. 2 shows that processing system 217 includes audio processing engine 237, which in turn includes non-volatile memory 288, in other implementations the different modules may be partitioned in a different manner without departing from the scope and spirit of the present disclosure. For example, the processing system 217 may include solid state drives, magnetic disk drives and other hard drives. The processing system 217 may also incorporate flash memory including NAND memory, NOR memory and other types of available memory. The processing system 217 may also include read only memory (ROM), programmable ROM, electrically erasable ROM (EEROM), and other available types of ROM. The processing system and the operating system and other applications relevant to the search engine functionality may be updateable, wirelessly via a network or otherwise. As noted, the memory (e.g., DRAM 211) in the processing system 217 may further include one or more cache memories, which may also be integrated into one or more individual processors/central processing units (CPUs) as L1 caches. The caches may be embedded within the processor, or they may be discrete devices, or some combination thereof.

The processing system 217 in some implementations may include a system-on-a-chip (SoC), or more than one SoC for performing dedicated or distributed functions. Thus, as noted, the processing system 217 in this disclosure may include hardware implementations such as digital signal processors (DSPs), application-specific integrated circuits (ASICs), field programmable gate arrays (FPGAs), discrete combinational logic circuits, and the like. In these configurations, the processors may be coupled together via different circuit boards to form the processing system 217. In other embodiments, the processors and other functional modules may be combined on a single printed circuit board or integrated circuit device.

A crystal oscillator (X-OSC) 294 is shown attached to the memory interface circuit 235 and the three processors 231A, 231B, and 231C. The crystal oscillator 294 may be used for clock operations, such as in the timing of received or transmitted signals. Separately, combinational logic 259 is shown for performing various digital hardware tasks. Data can be exchanged between the combinational logic 259 and the other components of the processing system 217 using bus 279. The combinational logic 259 may include one or more encoders, decoders, multiplexors, demultiplexors, Boolean logic circuits, and other digital hardware elements.

The audio processing engine 237 includes that portion of the processing system 217 for processing various components used in VAs including, for example output and input audio paths for respectively transmitting and receiving audio data streams. It will be appreciated that in many architectures, the functions executed by the audio processing engine 237 may alternatively or additionally be executed by other portions of the processing system 217. These other portions may include, for example, one or more of processors 231A, 231B, and 231C, and combinational logic 259. Thus, in various embodiments, portions of audio processing engine 237 may be physically integrated with other portions of the processing system 217.

The audio processing engine 237 in the embodiment of FIG. 2 includes a TTS module 245 for converting text generated by one or more of the processors 231A, 231B, and 231C into analog signals that may be amplified and output via loudspeakers as a synthetic voice for a user to listen and interpret. To perform this task, TTS module 245 may have built therein a digital-to-analog converter (DAC) for converting a digital text signal into an analog signal. In an alternative embodiment, TTS module 245 may use a separate DAC 243, or a plurality of such DACs, to accomplish a similar function. In addition, the TTS module 245 may pass the output electrical speech signal to a synthetic speech generator 241, in some embodiments before the signal from the TTS module 245 is converted to analog form. The synthetic speech generator 241 receives the audio information from the TTS module 245 and uses the speech data to assign a set of parameters (e.g., a vocal frequency, dynamic range, etc.) that represent an identifiable speech signature, often a female voice. The parameters that form the signature may be used to reproduce recognizable speech when the signal is passed through the loudspeakers. For example, the synthetic speech generator 241 may forward the output data stream to an external voice processor 251 for processing and conditioning the data stream before the data stream is passed to the internal transceiver 257. For example, the external voice processor 251 may perform amplification, filtering, noise-shaping and other audio processing functions.

The DAC 243 may output an analog version of the audio signal to op-amps 247 and/or to other amplifiers for boosting the signal power. The amplified signal may then be passed via the speaker interface 253 out to one or more loudspeakers 255 for outputting synthetic speech including instructions, requests for clarification, and other data relevant to an ongoing VA session. In other embodiments, such as where the TTS module 245 includes the synthetic speech generator function, the DAC, amplifier, and other components that may be needed depending on the architecture, TTS module 245 may forward the output signal to internal transceiver 257. Internal transceiver 257 may then output the speech signal using speaker interface 253 and loudspeakers 255. The loudspeakers 255 (which may include a single loudspeaker in some embodiments) in turn output the synthetic speech. The audio processing engine 237 may further include DC/DC converter 239, which may be used for transferring a DC power or voltage to different levels if so needed by different portions of the system.

In a similar manner, a user may use one or more microphones 261 to input human speech via microphones 261. The microphones 261 may convert the acoustic speech into electrical signals. The electrical signals representing the speech may pass through a microphone interface 295 and may be transmitted to internal transceiver 257. Internal transceiver 257 may thereupon forward the received electrical speech signals to a speech recognition module 265. Speech recognition module 265 may attempt to interpret the input speech using voice biometric procedures. Speech recognition module 265 may perform a variety of functions looking for patterns, using reference models, and processing the input signals using potentially a variety of existing techniques. It will be appreciated that in other configurations, the speech recognition functions performed by speech recognition module 265 may additionally or alternatively be performed, in part or in whole, by other components of processing system 217, including by one or more of the processors 231A, 231B, and/or 231C.

As noted, one drawback associated with present VAs and eliminated by the apparatus in FIG. 2 is that the microphones 261 may also receive synthetic speech that may be ongoing during a session. In accordance with various aspects, the speech recognition module 265 includes a voice biometrics unit 266, which is described in greater detail below. The received synthetic speech may be recognized by the speech recognition module 265 of the audio processing engine 237 and processed as speech. The synthetic speech may include a wake word. The determination that a wake word is present may be forwarded to one of the processors in some embodiments. The processor(s) may thereupon terminate the existing VA session and activate a new one in response. Thus, an unintended invocation of the VA may occur in this manner.

According to various aspects of the disclosure, when the VA apparatus is initially set up, voice biometrics is used on the synthetic speech generated by synthetic speech generator 241. In the context of a vehicle, for example, synthetic words or phrases may be generated by the synthetic speech generator 241 (or in other embodiments, by one of the processors). The synthetic speech may be reproduced over the loudspeakers 255 and received via the microphones 261. The audio data may be forwarded via the microphone interface 295 and internal transceiver 257 to the speech recognition module 265 and the voice biometrics unit 266. The voice biometric unit 266 may create one or more voiceprints using the synthetic speech. The word or phrase may constitute or include the wake word, and in some embodiments, other words, phrases, and sounds. The word or phrase may be reproduced a number of times over the loudspeakers 255. The speech recognition module 265 and voice biometrics unit 266 may use these repetitions of synthetic speech to create a voiceprint from which subsequent utterances of synthetic speech may be recognized as VA synthetic speech. The generated biometrics information may temporarily be stored in DRAM 211 during the synthetic audio reproduction and voiceprint generation process. The resulting voiceprint may include a plurality of voiceprints in some embodiments. The resulting voiceprint is thereupon stored in non-volatile memory 288, such as a magnetic or solid-state drive, flash memory, or the like.

The process of self-learning the voiceprint may apply equally to a user. For example, a driver of a new vehicle equipped with a VA may initially be prompted to say a wake word (or other text) a number of times. One or more voiceprints uniquely identifying the speech of the driver (or another user) may be generated. In various aspects, the voiceprints relevant to both the synthetic speech and the user speech may be stored in non-volatile memory 288.

Further, in other embodiments, after the voiceprints are created, the voiceprints may be uploaded to a remote storage such as cloud storage using transceiver 215 (discussed below). The relevant voiceprints may be downloaded when they are needed. Maintaining this information on a cloud storage may advantageously make accessible relevant voiceprint information for the same kinds of vehicles. In other embodiments, precision may dictate that the synthetic voiceprint be generated in the same vehicle.

The above principles may apply with equal force to non-vehicular VAs, and synthetic speech may be used to generate corresponding voiceprints to obviate the same problems with self-invocation, e.g., at a personal computer, tablet, laptop, mobile device, smartphone, and numerous other existing or emerging devices in the consumer marketplace.

After the voice biometrics unit 266 and speech recognition module 265 finalize setup and create the relevant voiceprints, the VA apparatus 200 is ready for use. As in other embodiments, the setup procedures may alternatively be performed, in part or in whole, by the one or more processors 231A, 231B, and 231C.

During regular use of the VA apparatus 200 (after setup), when audio data is received from the microphones 261 and input to the speech recognition module 265 from the internal transceiver 257, the audio data may be routed to the voice biometrics unit 266. The voice biometrics unit 266 may be configured to determine whether the received audio stream includes the voiceprint of the VA. For example, the processing system 217 may use the voice biometrics unit 266 to compare the received audio signal with the synthetic voiceprint created at setup and stored in DRAM 211 or in non-volatile memory 288. When the audio stream matches the synthetic voiceprint of the VA apparatus 200, the audio stream is not further routed for wake word processing and the processing system 217 refrains from invoking a new speech session. However, when the audio stream does not match the synthetic voiceprint of the VA apparatus 200, the audio stream is routed to one of the processors (or in some embodiments, to a portion of the speech recognition module 265) for wake word processing. Wake word processing, which includes the wake word detection function, may be performed by the speech recognition module 265, or by one or more of the processors 231A, 231B, and 231C. If the audio stream is not based on the VA and includes a new wake word, the processing system 217 may invoke a new VA session.

The functions of the voice biometrics unit 266 and/or speech recognition module 265 may be run as executable code on a processor. In various embodiments, the voice biometrics unit 266 may include dedicated hardware, updatable firmware or other components within the processing system 217 or the included audio processing engine 237. While the voice biometrics unit 266 may reside within the speech recognition module 265 as shown, the physical implementation of the circuits may be different. For example, in some embodiments the voice biometrics unit 266 is an autonomous module within the audio processing engine 237 or other parts of the processing system 217. As noted, in other embodiments the voice biometrics unit 266 may be executed as code on one or more of the processors 231A, 231B, and/or 231C. In some embodiments, the voice biometrics unit is used for comparing audio data with synthetic or user voiceprints during regular VA use, while the initial voiceprint creations during setup are performed by the processors 231A, 231B, and/or 231C. In other embodiments, the opposite may be true, with the voice biometrics unit 266 reserved for initial voiceprint generation during setup. In still other embodiments, the synthetic voiceprints are retrieved from a remote location (e.g., a cloud-based network) during setup. The processing system 217 may then create additional voiceprints, synthetic or otherwise, during setup in some cases.

The VA of FIG. 2 may further include an external transceiver 215 coupled to the processing system 217. The external transceiver may be used to perform various communication functions, such as transmitting information to other modules in a vehicle to instruct those modules to perform a task requested by a user. Transceiver 215 may include a network interface card (NIC) 219, or a plurality of them, for exchanging signals between separate modules or devices (e.g., a mobile device, a cellular-based remote location, etc.) over a plurality of wired and wireless networks. For example, NIC 219 may use wired interface 221A to transmit and receive signals over a cable 223A. Transceiver 215 may further include a wireless transmitter (WL Trm) 225 for transmitting signals over a wireless network. In an embodiment in which a wireless network link is established, the cable 223A may instead be connected to an antenna (omitted for clarity). The wireless transmitter may use the crystal oscillator 294 for establishing a clock signal. In embodiments where the wireless transmitter 225 further includes receiver functionality, the crystal oscillator may also be used to recover the incoming clock signal from the data signal, e.g., using a phase-locked loop. The transceiver 215 may also include a power interface 231 for providing electrical power, such as when the VA is implemented as an ECU of a vehicle. Power interface may include three power cables 223B, 223C and 223D for providing power to the module. It will be appreciated that the power interface need not be located at or adjacent the transceiver 215, and other physical locations may be equally suitable. Transceiver 215 may also include a USB interface 267 for managing USB protocols and exchanging signals over one or more USB ports, as available.

Advantageously, the use of the speech recognition module 265 and voice biometrics module 266 with synthetic speech may operate to substantially eliminate false alerts otherwise triggered by the VA.

Other aspects of the disclosure include using the user's voiceprint described above to allow the user to “barge in” or interrupt an existing VA session. Barging in allows a user to trigger a new session while the speech playback of the VA module 200 is active. As noted, the voice biometrics unit 266 and speech recognition module 265 may be used to establish a user voiceprint during setup of the VA module 200. Subsequently, when an audio stream other than synthetic speech is received during the VA's playback, the speech recognition module 265 and voice biometrics unit 266 may be used to determine whether the audio stream matches the user voiceprint. If a match is found, the processing system 217 may allow the barge in and invoke a new VA session based on the user's use of a wake word. In various embodiments, the aforementioned actions may also be performed by one or more of the processors 231A, 231B, and 231C.

These aspects of the disclosure beneficially allow the user to invoke a new session immediately as desired, while avoiding invoking a false session based on the synthetic speech. In some cases, the VA module 200 is configured to selectively invoke sessions for authorized users. In this case, the processing system 217 may selectively allow invocation of a session and interruption of a current session by an authorized user, while denying invocation of a session to unauthorized users whose speech patterns do not match an existing voiceprint profile. These features may be used in connection with other VA devices, and not merely VAs embedded in a vehicle.

It should be noted that during setup, the processing system 217 may use convolved variants of speech feedback during both synthetic speech recording and user speech recording. For example, the processing system 217 may modify the synthetic speech to take into account the specific vehicle environment, and the position and number of in-vehicle microphones, to more effectively mitigate undesired VA invocations.

In other aspects, iterative processing of an audio stream may occur in cases when active user speech and synthetic speech are occurring simultaneously. For example, the processing system 217 may iteratively perform computational procedures as needed to help ensure that voice biometrics processing occurs in a sequential manner to accurately perform the relevant voiceprint comparisons and avoid unwanted VA invocations.

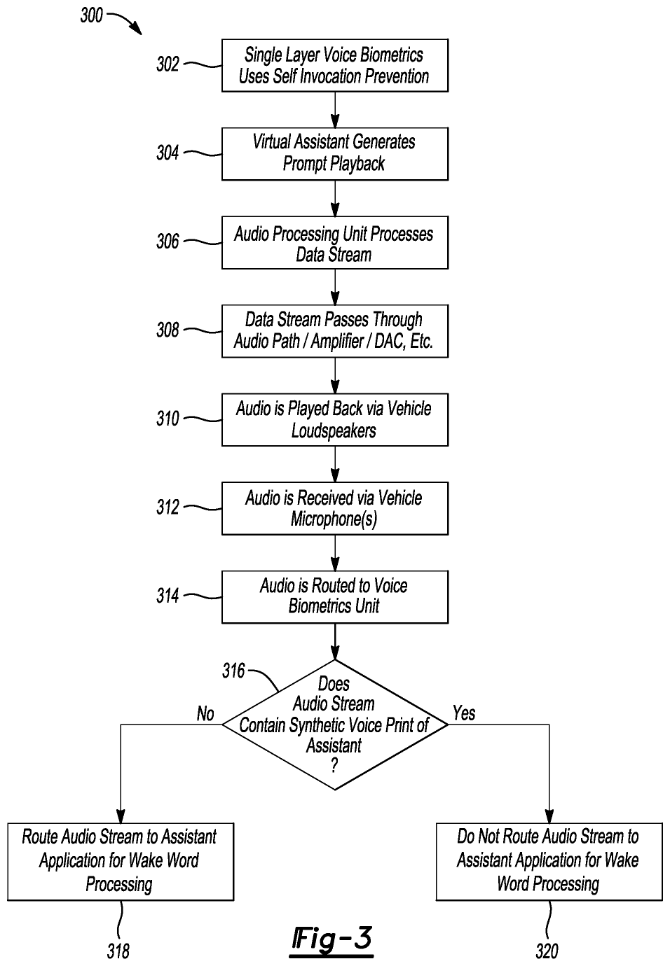

FIG. 3 is a flowchart 300 describing techniques for mitigating unintended invocations of a virtual assistant according to various embodiments. The steps in FIG. 3 may be performed by the processing system 217 of VA module 200 including one or more of processors 231A, 231B and 231C (or a different number of processors or processor cores in other embodiments). The steps in FIG. 3 may in various embodiments be performed by the audio processing engine 237 including speech recognition module 265 and voice biometrics unit 266, along with additional and intervening components or circuit elements.

Beginning at step 302, the processing system 217 may execute a single layer voice biometrics application configured to use synthetic speech-based voiceprints (e.g., during VA setup) to prevent inadvertent self-invocation of the VA during regular use. The VA may be in the process of playing back an audio stream in response to a user request. At step 304 after identifying the relevant data, the VA may proceed to generate playback of identified audio content. At step 306, audio processing components may process the identified data, for example, by serializing it, filtering it, or otherwise preparing it for acoustic rendering. The data stream at step 308 thereupon may pass through an audio path of carefully-matched components, including one or more amplifiers, DACs, and the like.

The analog audio stream is then sent to the vehicle loudspeakers at step 310, where the audio data is reproduced as speech (or in some cases, other acoustic content like music). As the audio is being played back, the synthetic audio, potentially in addition to audio from another source (e.g., the driver, ambient vehicle noise, etc.), is received at the vehicle microphone(s) at step 312.

In this embodiment, the audio stream received at step 312 is then routed to the voice biometrics unit at step 314, which may be a processor, a dedicated module, or a combination of components. The processing system 217 may retrieve the synthetic voiceprint created during setup of the VA (or in some embodiments, received from a remote source such as a cloud-based network). Thereupon, at step 316, the processing system determines whether the audio stream matches (e.g., includes or otherwise contains) the synthetic voiceprint of the VA. If not, the processing system concludes that the audio stream is not synthetic speech originating from the VA. Control in this event passes to step 318, where the processing system routes the audio stream to the relevant VA application or component to undergo wake word processing—i.e., to determine whether the audio stream includes the VA's wake word.

Conversely, if the audio stream does match (e.g., includes or otherwise contains) the synthetic voiceprint, the processing system concludes that the audio stream is synthetic speech originating from the VA itself. At step 320, the processing system refrains from routing the audio stream further. That audio stream, or relevant portion thereof, may be discarded.

Frequently, the voiceprint may include the wake word. The processing system may perform the steps 316, 318 and 320 using different techniques. The system described above with reference to FIGS. 2 and 3 obviates the false invocations that often occur in vehicle-based VAs, as well as in other VAs. The latter category includes those VAs embedded in most different types of consumer devices. Because these VAs each include active microphones and therefore each receive feedback from synthetic speech, the VA embedded in the device may reduce the number of unwanted self-invocations through the use of the synthetic speech-based voiceprint.

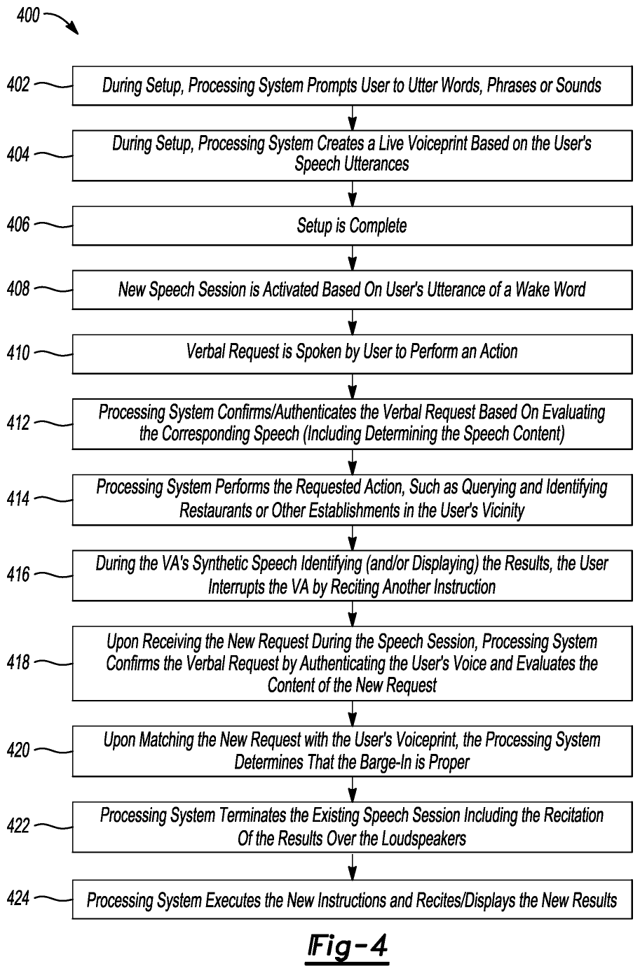

FIG. 4 is a flowchart 400 describing techniques for allowing a user barge-in upon recognizing the user's voiceprint. The steps in FIG. 4 may be performed by the processing system 217 of VA module 200 including one or more of processors 231A, 231B and 231C (or a different number of processors or processor cores in other embodiments). The steps in FIG. 4 may in various embodiments be performed by the audio processing engine 237 including speech recognition module 265 and voice biometrics unit 266, along with additional and intervening components or circuit elements.

Initially, during a setup procedure of the VA, the processing system at step 402 may prompt the user to utter certain words, phrases, or sounds. At step 404, during setup, the processing system may create a live voiceprint (which may be construed to include one or more live voiceprints) based on the user's speech utterances responsive to the respective prompts. The live voiceprint represents the acoustic signature of the user. In certain embodiments, the VA may restrict use to authorized users, such as the owner or driver of a vehicle or the owner of a smartphone, for example. One or both of the (1) live voiceprints, and (2) voiceprints created from the synthetic speech, may be stored in non-volatile memory 488 (FIG. 2), or they uploaded to a cloud network in some configurations. In the latter case, the voiceprints may subsequently be retrieved over a wireless network or a wired network. Setup is completed at step 406.

Referring now to step 408 of FIG. 4, a new speech session may be activated based on a user's utterance of a wake word. In the example embodiment where the VA is limited to authorized users, the processing system may authenticate the user's voice. During the speech session, the processing system may be listening for a further utterance of speech to direct the VA. The user may speak a verbal request asking the VA to perform some action, as in step 410. The scope of possible actions is diverse, and may broadly include providing directions, identifying restaurants in the user's vicinity, activating another application, and so on.

Responsive to the user's verbal request during the newly activated speech session, at step 412, the processing system may further confirm, using the audio output circuits including the TTS module 245 (also referred to as the text-to-speech converter) and loudspeakers 255 (FIG. 2), the verbal request of the user upon evaluating the speech utterances of the user that constitute the request. That is to say, the processing system may authenticate that the user is an authorized user by comparing the user's voiceprint to the incoming audio stream, in configurations where such authorization is required. The processing system also evaluates at step 412 the input audio stream using the speech recognition module 265 or one or more processors to determine the content of the request.

Upon determining the presence and content of a valid request or instruction, the processing system at step 414 proceeds to perform the requested action or comply with the requested instruction. For the example of FIG. 4, it is assumed that the request related to identifying restaurants in the user's vicinity. The VA may summarize the results and display additional or corresponding information on an output display.

At step 416, during the VA's recitation of synthetic speech relaying the results, which may also include displaying a list of the restaurants on a touch screen display in an exemplary vehicle infotainment system, the user may interrupt the VA by reciting another instruction. For example, the user may hear the VA identify a particular restaurant and then immediately ask for the directions to the restaurant without waiting for the VA to conclude its output speech. Upon receiving the new request during the speech session, the processing system may proceed to authenticate the user's voice and evaluate the content of the new request (step 418). After matching the new request with the user's voiceprint stored in non-volatile memory 288 or DRAM 211 (FIG. 2), the processing system at step 420 may allow the barge-in. That is, at step 422, the processing system may terminate the existing speech session including the recitation of the results over the loudspeakers. At step 424, the processing system may proceed to execute the new request or instruction and recite and/or display the new results.

Barge-in selectively allows the speech session to be interrupted only when the audio stream corresponding to the new request matches the user's voiceprint created during setup. Among other advantages, this beneficially enables the VA to ignore extraneous speech and noises made by unauthorized users or irrelevant acoustic artifacts associated with the environment in which the VA is implemented.

Traditional techniques that have been proposed or implemented to address the aforementioned problems with self-invocation are either inferior or unworkable. For example, echo noise cancellation is non-trivial in the automotive environment, with many factors making it difficult for a “one size fits all” tuning solution for different manufacturers. At the very least, such an attempted solution is prohibitively expensive because more elements of the attempted solution need to be tailored to individual environments. By contrast, a biometrics solution as proposed herein provide a more uniform solution with less tailoring needs, while providing broader and more effective self-invocation protection.

More fundamentally, the solution herein may alleviate problems that arise in traditional attempted solutions to VA self-invocation. These problems include, without limitation, the fact that different vehicle and acoustic environments change the audio path (e.g., microphone placement, audio loudspeaker placement relative to the microphone, etc.). A single solution based on echo noise cancellation is not achievable under these circumstances. Another problem inherent in traditional techniques includes different vehicle amplifier configurations (external vs. internal, different suppliers, different media tuning, and the like). Further, different VAs have different processing needs/requirements, which exacerbates the problems inherent in traditional approaches.

For complex audio processing-based solutions, it bears noting that audio characteristics include other use-cases, like hands free calling, which include their own processing needs to be taken into account. Audio processing of the proposed traditional approaches may be highly CPU-intensive. The need for complex logic in various situations can be costly. By contrast, while the claimed principles may be implemented with ease on sophisticated and complex processing circuitry, the solution described herein may also be achieved with great success using modest hardware systems, including single processor solutions.

The benefits of the voice biometrics solution as disclosed herein are manyfold. For one, the solution is effective and may work with the different VAs in spite of their own physical differences and in spite of environmental differences. Another benefit is that the voice biometrics solution proposed herein may result in low CPU footprint modules that alleviate some of the processing needs of the audio processing engine. These benefits are further evidenced by the fact that many traditional audio processing solutions relevant to this problem of VA self-invocation struggle to pass the relevant certifications. The disclosed biometric solution likely rectifies this problem. Yet another benefit is that the audio signals that are specifically targeted for the VA (i.e., not unwanted self-invocation audio) may be enhanced by the solutions proposed herein, rather than made problematic as in certain echo-cancellation based proposals.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims. Moreover, this disclosure expressly includes combinations and sub-combinations of the elements and features presented above and below.

What is claimed is:

1. An apparatus, comprising:
a processing system configured to control a virtual assistant, the processing system having stored in a memory at least one voiceprint created using voice biometrics based on recorded utterances of synthetic speech from the virtual assistant, the at least one voiceprint used to prevent self-invocation of a virtual speech session.

2. The apparatus of claim 1, further comprising:
an amplifier coupled to the processing system;
loudspeakers coupled to the amplifier; and
a microphone,
wherein the processing system is encased in a vehicle and the loudspeakers and microphone are positioned to include one or more respective outputs and inputs in a cabin of the vehicle.

3. The apparatus of claim 2, wherein the processing system is further configured to:
generate voice prompt data including a wake word;
send the voice prompt data to the amplifier to allow reproduction over the loudspeakers;
receive audio information via the microphone;
refrain from invoking a new speech session when the received audio information matches the at least one voiceprint; and
invoke a new speech session when the audio information includes the wake word, and the wake word does not match the at least one voiceprint.

4. The apparatus of claim 2, wherein the at least one voiceprint is created using convolved variants of the synthetic speech specific to an environment of the vehicle and characteristics of the microphone that reproduce undesired invocations of the virtual assistant.

5. The apparatus of claim 1, wherein the processing system is further configured to store live voiceprints in the memory based on speech utterances of an intended user.

6. The apparatus of claim 5, wherein the processing system is further configured to recognize an intended user based on the stored user voiceprints to thereby enable a barge-in via the microphone while speech playback is active over the loudspeakers.

7. The apparatus of claim 1, wherein the synthetic utterances include a plurality of noisy and convolved variants thereof.

8. The apparatus of claim 1, wherein the at least one voiceprint is used to prevent self-invocation of the virtual speech session by matching the at least one voiceprint with an incoming audio stream.

9. The apparatus of claim 1, wherein the processing system is further configured to iteratively process a received audio stream, wherein when active acoustic input from an intended user and speech playback of the virtual assistant overlap in time, the processing system tests the voice biometrics sequentially to mitigate an undesired invocation of a virtual session.

10. A vehicle, comprising:
a vehicle body defining a cabin;
a processing system including a memory and an audio processing engine, the memory including code that, when executed by the processing system, controls a virtual assistant, the audio processing engine being coupled via at least one audio path to loudspeakers and a microphone having respective inputs and an output positioned in the cabin, the audio processing engine configured to route data including a prompt from the processing system to the loudspeakers for acoustic playback and to receive acoustic data from the microphone;
wherein the microphone is configured to receive a wake word for activating the virtual assistant; and
wherein the memory is configured to store at least one voiceprint including a wake word created based on pre-recorded utterances of synthetic speech from the virtual assistant, the at least one voiceprint used by the processing system to prevent self-invocation of a virtual speech session by determining whether the received wake word includes the at least one voiceprint.

11. The vehicle of claim 10, wherein:
the microphone is coupled to an input of the audio processing engine;
the loudspeakers are coupled to an output of the audio processing engine;
the loudspeakers and the microphone are configured to output voice information and receive input acoustic data, respectively; and
the audio processing engine is configured to compare the input acoustic data with at least one preconfigured voiceprint created using utterances of an intended user to enable barge-in while speech feedback is currently active.

12. The vehicle of claim 10, wherein the processing system is preconfigured to create the at least one voiceprint by convolving synthetic speech utterances to emulate speech made in a cabin of the vehicle.

13. The vehicle of claim 10, wherein the processing system is preconfigured to create the at least one voiceprint by mixing noise into synthetic speech utterances that emulate noise made in a cabin of the vehicle.

14. The vehicle of claim 10, wherein the memory includes code that, when executed by the processing system, causes the processing system to iteratively process an audio stream when a live speech session and synthetic speech playback from the virtual assistant overlap in time.

15. The vehicle of claim 14, wherein the audio processing engine is configured to cause voice biometrics processing to occur sequentially between the live speech session and the synthetic speech playback to mitigate an unintended invocation.

16. A virtual assistant apparatus, comprising:
a wireless transceiver; and
a processing system coupled to the wireless transceiver and configured to:
retrieve, from a cloud network using the wireless transceiver, one or more voiceprint variants created using pre-recorded utterances of synthetic speech made in a vehicle cabin, the one or more voiceprint variants including a wake word;
receive speech input via a microphone positioned in the vehicle cabin;
compare the speech input to the one or more voiceprint variants; and
prevent self-invocation of a virtual speech session when the speech input matches any of the one or more voiceprint variants.

17. The apparatus of claim 16, wherein the processing system is further configured to:
respond, using another instance of synthetic speech over one or more loudspeakers, to a verbal request spoken by a user to perform an action;
create at least one voiceprint based on the another instance of synthetic speech; and
perform the requested action.

18. The apparatus of claim 17, wherein the processing system is further configured to create a live voiceprint based on speech utterances of the user, the live voiceprint created for authenticating the user in a subsequent session.

19. The apparatus of claim 17, wherein:
the processing system is further configured to confirm, using a text-to-speech converter, a verbal request of the user based on the speech utterances of the user while a speech session is active; and
when the user utters another request during the speech session, the processing system is configured to suspend the speech session to enable a barge-in to a new speech session via the another request when the another request matches a user voiceprint.

20. The apparatus of claim 17, wherein the processing system is further configured to record user speech utterances including a wake word and to upload voiceprints created therefrom to a cloud-based network.
